(19) United States
(12) Patent Application Publication
(10) Pub. No.: US 2021/0307370 A1
(43) Pub. Date: Oct. 7, 2021

(54) Fruit Chip

(71) Applicant: Dave and Kenny's, LLC, Ferndale, MI (US)

(72) Inventor: David Shammas, Ferndale, MI (US)

(21) Appl. No.: 17/335,790

(22) Filed: Jun. 1, 2021

Related U.S. Application Data
(60) Provisional application No. 63/003,325, filed on Apr. 1, 2020.
(60) Provisional application No. 63/195,393, filed on Jun. 1, 2021.

(51) Int. Cl. A23L 19/00; A23B 7/02; A23P 30/10

(52) U.S. Cl. CPC A23L 19/09; A23V 2002/00; A23P 30/10; A23B 7/02

(57) ABSTRACT

A chip, snack or other food product derived from fruits and/or vegetables is contemplated. The chip may be derived predominately from pineapple and processed according to unforeseen techniques and ingredient ratios to process a crispy chip without the use of additives and preservatives.

### CROSS-REFERENCE TO RELATED APPLICATIONS

This application claims the benefit of U.S. provisional application No. 63/003,325, filed Apr. 1, 2020, and U.S. provisional application No. 63/195,393, filed Jun. 1, 2021, the disclosures of which are incorporated in their entireties by reference herein.

### TECHNICAL FIELD

The present invention relates to chips, snacks and other food products derived from fruits and/or vegetables, such as but not necessarily limited to a chip derived predominately from pineapple.

### BACKGROUND

Food producers have long desired a fruit and/or vegetable-based snack due to the many benefits associated with consuming fruits and vegetables. In their naturally occurring state, fruits and vegetables of the types used within snacks have a relatively high moisture content that tends to cause the resulting snack to have a soft and chewy texture. The soft and chewy texture tends to be unpleasing to consumers and the presence of moisture tends to limit the shelf-life life of such snacks. Food producers have tried to reduce the moisture content and extend the shelf-life with additives, chemicals, preservatives, silica packs, etc., however, a growing desire exists for producing snacks without the use of such non-naturally occurring ingredients and additives.

### BRIEF DESCRIPTION OF THE DRAWINGS

FIG. 1 illustrates a system for producing a fruit chip in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

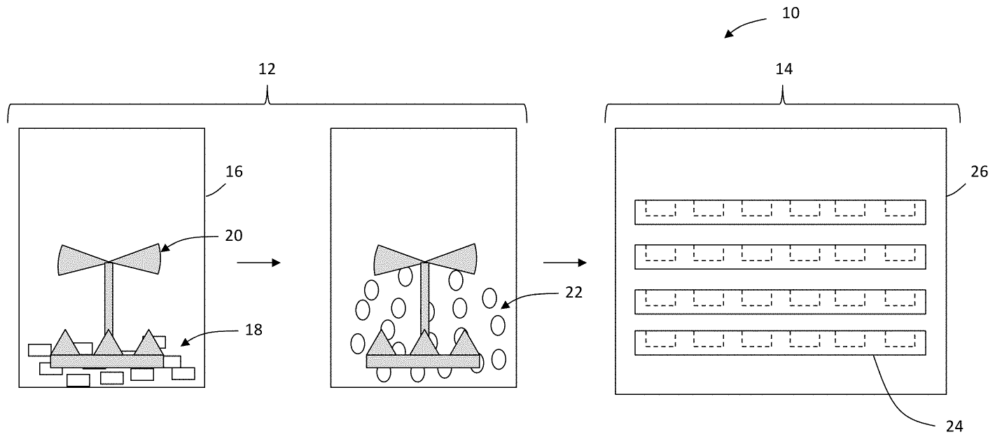

FIG. 1 illustrates a system 10 for producing a fruit chip in accordance with one non-limiting aspect of the present invention. The system 10 enables the fruit chip to be produced using naturally occurring ingredients, such as but not limited to fruits and/or vegetables, whereby the resulting chip, without the use of preservatives and/or additives, may have a crispy texture and a relatively long shelf-life. The ability to not only produce a fruit chip having a long-shelf-life, but the ability to also produce the fruit chip with a crispy texture is believed to meet a long-felt need of fruit-based snack producers. The crispness of the fruit chip may be particularly beneficial due to consumers typically finding the crunchiness and attendant crunching sounds pleasing and satisfying, particularly with respect to providing a multi-sensory experience differing from those usually associated with fruit-based snacks. As an added benefit, the fruit chip may produce the crispy texture and retain the nutritional benefits of the fruit and vegetables without frying and without direct exposure to radiant heat.

The system 10 may include a blending process 12 and a drying process 14. The blending 12 process may include a vat, a mixer, a blender or other element 16 sufficient to facilitate mixing ingredients 18. One non-limiting aspect of the present invention contemplates producing the fruit chip without additives and without preservatives. The use and processing of the ingredients 18 may be varied such that the ratio of one ingredient 18 to another may vary from their naturally occurring state in order to produce unforeseen or unintended results without having to rely upon additives. A mixing blade 20 may be used to mix the ingredients 18 until creating a foam 22, such as by emulsifying or aerating a combination of fruit and vegetables until increasing a density by volume of the ingredients 18 to a particular or desired level. The drying process 14 may include pouring the foam 20 into molds or other containers 24 for drying within a dehydrator 26 until producing crispy chips. The dehydrator 26 may be of the type using heated air and/or other non-direct energy sources to dry the foam 22 until a desired crispiness is achieved. The desire crispness may be determined through measurement or human verification, such as by measuring a surface texture, cracks/fractures, etc., e.g., a mechanical tester may be able to strike the surface of the chip or bend the chip until cracking to see if fractures form or audible sensations are generated, and/or empirical measurements of moisture, density, volume, etc. may be used, e.g., a 5-10% moisture by volume may be indicative of sufficient crispness.

One non-limiting aspect of the present invention contemplates producing the fruit chip primarily using pineapple, such as by removing the skin of a pineapple and adding one or more pieces of pineapple core and/or non-core to the mixer 16. The core may generally correspond with a central portion of the pineapple having a greater density and/or fiber content than the non-core. The non-core may correspond with a portion of the pineapple occurring between the skin and the core, which may have a greater density and sugar content than the core. The core may have high concentration of Bromelain as compared to the non-core, which can improve heart health and helps in thinning of the mucus in conditions like asthma and the core may contain polyphenols greater volumes amounts than pulp extracts. The pineapple may be mixed with other fruits and/or vegetables, depending on taste and preferences, and the pineapple may optionally be the predominant ingredient in order to maximize the benefits contemplated by the present invention, such as by limiting the fruits and vegetables being mixed such that the resulting form is at least 60-70% pineapple.

The blending process 12, particularly when blending specific fruits or vegetables, may maintain a certain ratio when considering the density of the initial pineapple foam blend and the addition fruit or vegetable to be added. The process of blending and maintaining specific foam density ratio may include use of a cyclonic blade or mixier, such as at peak wattage of 1400 to blend pineapple and core for a period of 120-180 seconds (exceeding the blending period of 120-180 seconds may result in an accumulation of heat and will begin to break down the foam and air molecules in the blend). When blending other fruit or vegetables, a ratio of 60-70% pineapple and core may be maintained to retain the foam density of the blend (exceeding the blend ratio may result in breakdown of foam density of blend). When adding certain fruits and vegetables, specific fiber content and viscosity of fiber may be adjusted depending on certain blends, e.g., viscous fruit such as mango and banana may have a threshold of 10-12% when adding to the pineapple blend and fibrous vegetables such as kale and carrot may have a 12-15% threshold when adding to the pineapple (exceeding these thresholds may result in breakdown of pineapple blend foam density and result in inadequate drying and texture). When blending fruit or vegetable to the pineapple, certain stages may be followed in the blending process, such as with a two blend process where, after 120 seconds of pineapple and core blended at 60-70% ratio, 40-30% secondary fruit or vegetable may be added at second stage at a time of 30-60 seconds or with a three blend process where, after 120 seconds of pineapple and core blended at 60-70% ratio, 30-20% secondary fruit or vegetable may be added at second stage at a time of 30-60 seconds and third fruit or vegetable at a ratio of 20-10% may be blended at third stage at a time of 10-30 seconds. The timing of the additional blends may be beneficial in producing the foam 22 with the sufficient amount of aeration and/or density by weight needed to produce the desired crispiness

The drying process 14 may follow particular time and temperature constraints in order to achieve a desired foam density and/or air bubbles needed for a crisp texture. The specific process of drying immediately after blending 12 when foam density is at its peak is contemplated. The drying process 14 may include the pineapple blend mix being immediately poured into silicone trays or other types of molds with a depth of 10-15 mm (thinner and/or thicker molds may be utilized without deviating from the scope and contemplation of the present invention, which may also correspondingly require more or less drying time to achieve desired crispness). A lower tray depth may result in drying too quickly and discoloration of fruit and vegetable blend as well as creating a texture too thin and crumbly. A deeper tray depth may result in the product inadequately drying and extend dry time to a point of discoloration of fruit and vegetable which may compromise flavor and texture. Molds or trays having the foam may be placed in a dehydrator with an internal temperature of 135 degrees for a period of 12 hours, which may be sufficient to reduce the foam from 10 mm to a final chip depth of 2 mm (e.g., a 80% reduction—a greater reduction may be achieved and may be desired with longer drying). Maintaining the structure of the foam 20 and air molecules while simultaneously drying the foam 20 may create the crisp texture as a lower temperature may allow the foamy mix to deflate and liquefy before it dries and a higher temperature may cook the fruit and vegetable blend rather than dry it and compromise flavor, texture, and vitamin content.

One non-limiting aspect of the present invention contemplates producing a foam 22 comprising pineapple and/or additional fruits and/or vegetables whereby the foam 22 is comprised of 60-70% pineapple, which may be beneficial in producing fruit chips having the characteristics of samples described in the certificate of analysis included in the above incorporated provisional. More or less than 60-70% pineapple may be used; however, less pineapple may not produce the desired texture and crispness and more pineapple may provide an unpleasant or tart taste. While the present invention may be beneficial in utilizing pineapple in its natural state, i.e., adding whole pineapples to the mixer following skin removal, which tends to result in an approximate 20% core and 80% non-core, the present invention also contemplates using an unnatural ratio of pineapple core versus non-core, such as by increasing the ratio of core to more than 20% core in order to produce a more fibrous structure or decreasing the ratio of core to less than 20% in order to produce lighter and crispier chip (drying and/or blended fruits/vegetables ratios may need to be correspondingly varied to in effect achieved the desired crispness). Aside from the benefits in producing the contemplated foam 22 and the nutritional benefits, maintaining the desired ratio of pineapple in the end product may be beneficial in maximizing shelf-life such that the shelf-life may be sufficient to sustain months within packaging without the use of preservatives and silica packs.

The mixing of the pineapple and/or other ingredients may be performed for purposes of emulsifying or aerating the mixture until a desired density by volume is achieved. One non-limiting aspect of the present invention contemplates mixing the ingredients in a cyclonic action whereby a portion of the resulting mixture begins to rise vertically as the ingredients turn into the foam 20. As shown in FIG. 1, the cyclonic action may be achieved with the mixing blade 20 having a lower portion with a blade, and optionally teeth, to cut up and whip the ingredients and an upper portion with a propeller to draw the ingredients upwards as the emulsification takes hold, such as of the type above incorporated provisional application. Such a two-stage mixing process may be beneficial in allowing the denser ingredients to be emulsified while the less dense, previously emulsified or more emulsified ingredients, may be drawn up out of the way, which may be helpful in preventing deflation while also maximizing mixing of the un-emulsified ingredients. While the present invention contemplates other mixing blades, such as a whisk, the blade 20 described as inducing the cyclonic action provides unforeseen and unexpected benefits in emulsifying the ingredients to an extent sufficient to produce the desired crispness when coupled with the contemplated drying process.

As described above, the present invention contemplates producing a fruit chip having a crisp texture and crunchiness far in excess of the previously produced, soft and chewy fruit snacks. The present invention is able to produce such a beneficial chip by unnaturally mixing ingredients to a corresponding unnatural state of emulsification/aeration (density by volume), and importantly, without adding unnatural ingredients or additives, i.e., while the ingredients are essentially left in their natural state, other than in some cases being added together in unnatural ratios, the blending process is conducted in a previously unforeseen manner to produce an entirely new and beneficial process for manufacturing crispy fruit chips. To assure crispiness and desired taste, while at the same time balancing health benefits and maximizing shelf-life, the present invention contemplates generating the foam to include 60-70% pineapple (core plus non-core) and emulsifying the pineapple and/or other ingredients increase their density by volume by at least 40%. The crispiest version of the fruit chip may be achieved with the blending process producing an approximately 100% increase in density by volume, which may be achieved if the tolerances and ingredient mixtures and processes described herein are closely followed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for producing a pineapple chip comprising:
mixing one or more pieces of pineapple until forming a foam having a density by volume at least 40% greater than the pineapple; and
dehydrating the foam until becoming crispy chips.

2. The method of claim 1 further comprising selecting the one or more pieces of pineapple to include at least one piece of core and at least one piece of non-core.

3. The method of claim 2 further comprising selecting the core and non-core such that an amount of core is approximately 20% to an amount of non-core is approximately 80%.

4. The method of claim 2 further comprising removing a skin from the pineapple prior to mixing such that the core and non-core are skinless when mixed.

5. The method of claim 1 further comprising dehydrating the foam at approximately 135° Fahrenheit for approximately 12 hours.

6. The method of claim 1 further comprising dehydrating the foam until the crispy chips create an audible or acoustical cracking sound when bent or chewed.

7. The method of claim 1 further comprising dehydrating the foam until the crispy chips fracture or form surface cracks when bent or chewed.

8. The method of claim 1 further comprising determining crispy chips to have been formed when a moisture or fluid content is no more than 5% by weight.

9. The method of claim 1 further comprising determining crispy chips to have been formed when 90% of a moisture or fluid content of the foam is removed.

10. The method of claim 1 further comprising pouring the foam into molds prior to dehydrating, each mold including no more than 15 millimeters of foam.

11. The method of claim 10 further comprising determining crispy chips to have been formed when a depth of the foam in the mold reduces by at least 80%.

12. The method of claim 1 further comprising mixing the pineapple with a cyclonic action, the cyclonic action characterized by drawing portions of the pineapple upwardly while mixing the pineapple into the foam.

13. The method of claim 1 further comprising mixing one or more pieces of fruit and/or vegetable with the pineapple such that the fruit and/or vegetable is included within the foam and the pineapple comprises at least 60% of the foam by weight.

14. The method of claim 13 further comprising mixing the fruit and/or vegetable into the foam after the foam has a density by volume at least 20% greater than the pineapple.

15. The claim 1 further comprising packaging the crispy chips for storage without using preservatives and without using silica packs.

16. The method of claim 1 further comprising dehydrating the foam without adding chemicals or additives.

17. The method of claim 1 further comprising mixing the pineapple into the foam without adding emulsifiers or thickening agents.

18. A crispy chip comprising:
approximately 60-70% pineapple;
approximately 40-70% non-pineapple fruit and/or vegetable;
the pineapple and non-pineapple being cyclonically blended into a foam; and
the foam being dried to form the crispy chip.

19. The crispy chip of claim 18 wherein the foam and the crispy chip include not additives and no preservatives.

20. A method for producing a chip comprising:
mixing with a cyclonic action approximately 60-70% pineapple with approximately 40-70% non-pineapple fruit and/or vegetable until becoming a foam, the foam having at least 90% less density by volume than the pineapple and non-pineapple, the pineapple including approximately 20% core and 80% non-core and 0% skin;
pouring the foam into molds, each mold including no more than 15 millimeters of foam; and
dehydrating the foam in the molds until forming crispy chips, the crispy chips being formed when each of the following occurs:
i) the foam has dehydrated at approximately 135° Fahrenheit for approximately 12 hours;
ii) a depth of the foam in the mold reduces by at least 50%;
iii) the crispy chips fracture or form surface cracks when bent or chewed; and
iv) the crispy chips create an audible or acoustical cracking sound when bent or chewed.
